(19) United States
(12) Patent Application Publication
(10) Pub. No.: US 2011/0161585 A1
(43) Pub. Date: Jun. 30, 2011

(54) PROCESSING NON-OWNERSHIP LOAD REQUESTS HITTING MODIFIED LINE IN CACHE OF A DIFFERENT PROCESSOR

(76) Inventors: SAILESH KOTTAPALLI, San Jose, CA (US); Jeffrey Baxter, Cupertino, CA (US); James R. Vash, Littleton, MA (US); Bongjin Jung, Westford, MA (US); Andrew Y. Sun, Cupertino, CA (US)

(21) Appl. No.: 12/647,458

(22) Filed: Dec. 26, 2009

(51) Int. Cl. G06F 12/08; G06F 12/00

(52) U.S. Cl. 711/122; 711/143; 711/144; 711/E12.017; 711/E12.024; 711/E12.037

(57) ABSTRACT

Methods and apparatus to efficiently process non-ownership load requests hitting modified line (M-line) in cache of a different processor are described. In one embodiment, a first agent changes the state of a first data and forwards it to a second, requesting agent who stores the first data in an alternative modified state. Other embodiments are also described.

### FIELD

The present disclosure generally relates to the field of computing. More particularly, an embodiment of the invention generally relates to techniques for efficiently processing non-ownership load requests hitting an modified line (M-line) in cache of a different processor.

### BACKGROUND

To improve performance, some processors may access data that is stored in a cache. Generally, data stored in a cache may be accessed more quickly than data stored in a main system memory. In systems with multiple processors and caches, various operations may have to be performed when handling load requests in caches that share data in a coherent fashion. The handling of these operations may determine the latency, bandwidth, and/or power consumed by the processor.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 5-6 illustrate block diagrams of embodiments of computing systems, which may be utilized to implement some embodiments discussed herein.

FIGS. 2-4 illustrate flow diagrams for processing non-ownership load requests hitting an M-line in cache of a different agent, according to some embodiments.

FIG. 7 illustrates a block diagram of portions of a processor core and other components of a computing system, according to an embodiment of the invention.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software (including for example micro-code that controls the operations of a processor), or some combination thereof. Also, the use of “instruction” or “micro-operation” (which may also be referred to as “uop”) herein may be interchangeable.

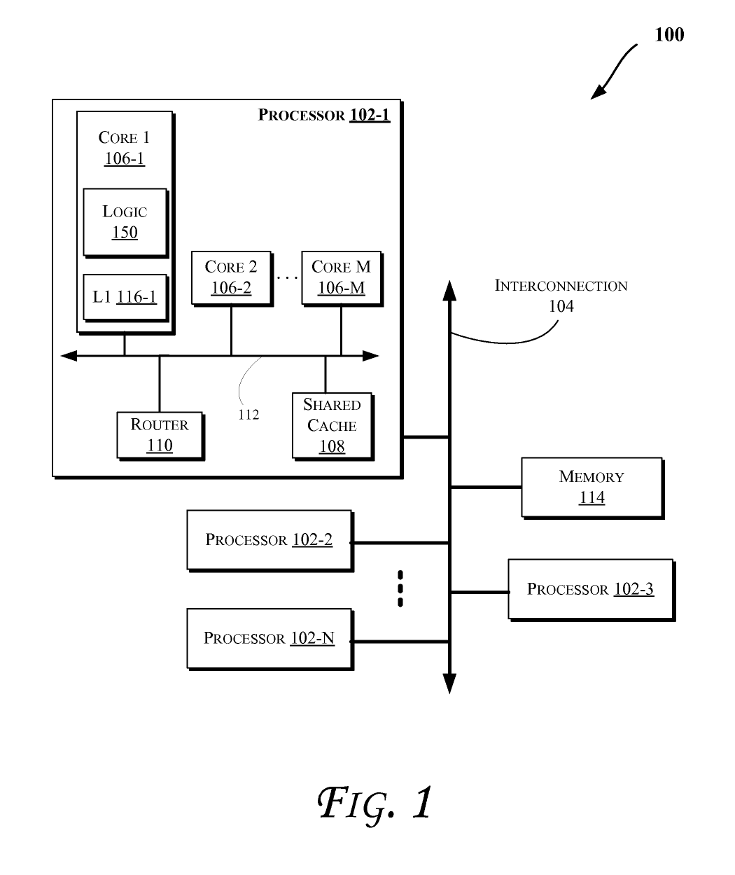

Some of the embodiments discussed herein efficiently process non-ownership load requests hitting a Modified line (M-line) in cache of a different agent/processor, e.g., in a multiple agent/processor or processor core computing system. Generally, a modified state of a cache line may indicate that the line is only present in the current cache and is dirty (it has been modified from the value stored in the main memory). Furthermore, the techniques discussed herein may provide for improved bandwidth, reduced latency, and/or reduced power consumption (e.g., for processors and/or memory devices). For example, some of techniques discussed herein may be applied in computing systems with large caches and with remote/coherent sharing across multiple such caches (such as the systems discussed with reference to FIGS. 1, and 5-6).

More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection network or bus 104. Also, in some embodiments, the processors 102 may each occupy a socket in the system and the sockets may couple to processors and/or other components of the system (e.g., via a printed circuit board). As shown, each processor may include various components, some of which are only discussed with reference to processor 102-1 for clarity. Accordingly, each of the remaining processors 102-2 through 102-N may include the same or similar components discussed with reference to the processor 102-1.

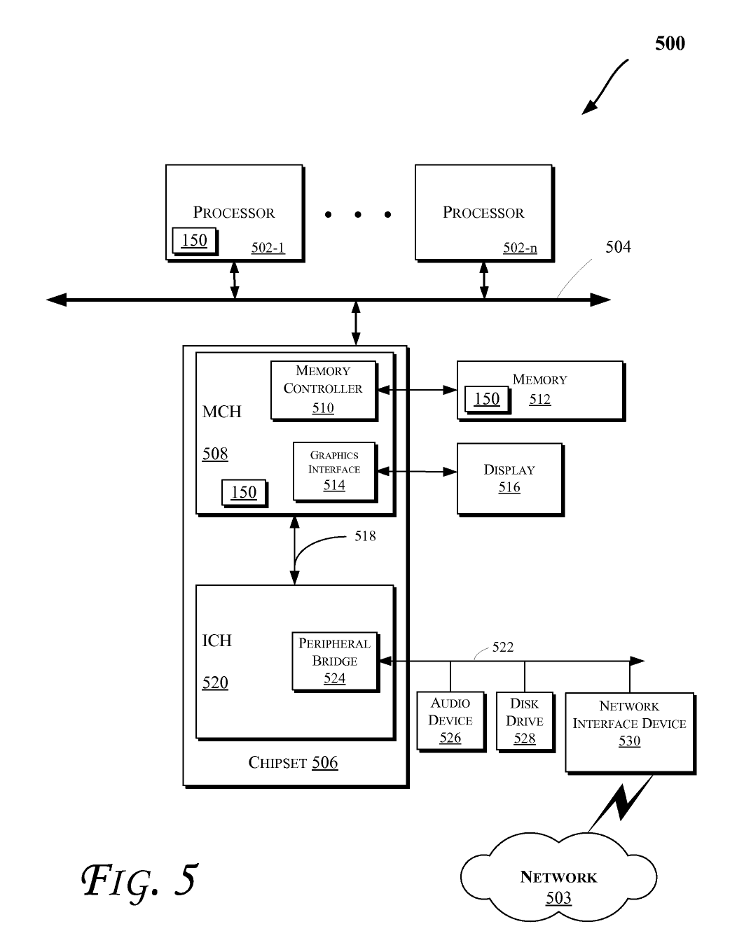

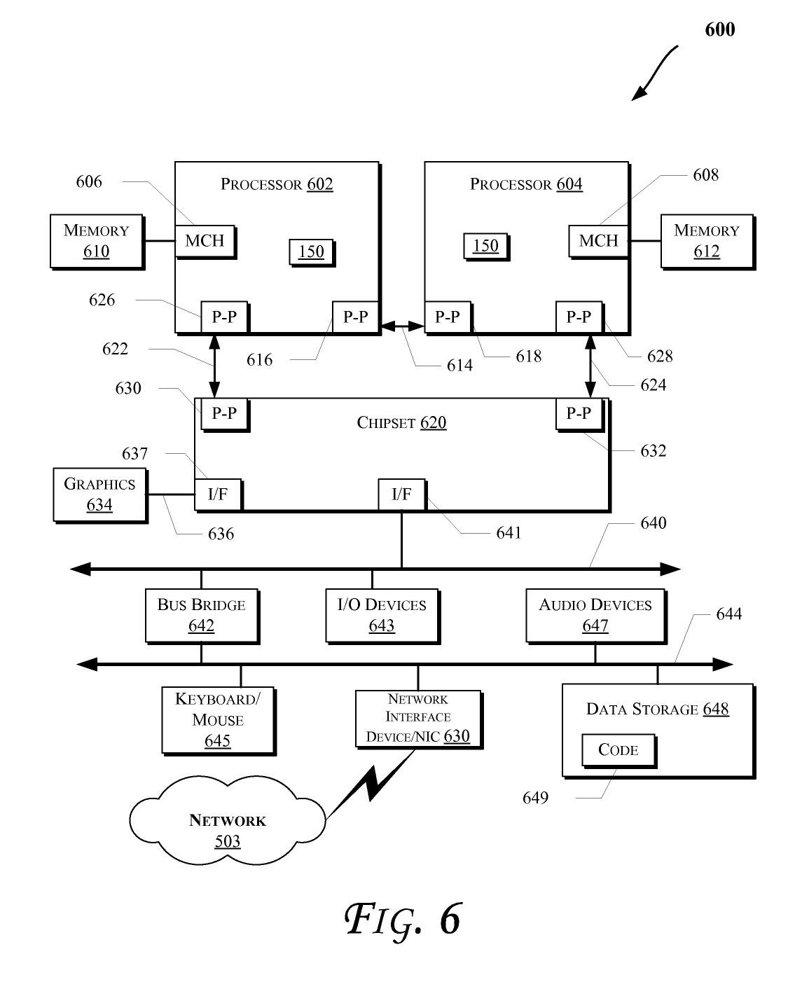

In an embodiment, the processor 102-1 may include one or more processor cores 106-1 through 106-M (referred to herein as “cores 106” or more generally as “core 106”), a shared cache 108, and/or a router 110. The processor cores 106 may be implemented on a single integrated circuit (IC) chip. Moreover, the chip may include one or more shared and/or private caches (such as cache 108), buses or interconnections (such as a bus or interconnection network 112), memory controllers (such as those discussed with reference to FIGS. 5 and 6), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The shared cache 108 may store data (e.g., including instructions) that are utilized by one or more components of the processor 102-1, such as the cores 106. For example, the shared cache 108 may locally cache data stored in a memory 114 for faster access by components of the processor 102. In an embodiment, the cache 108 may include a mid-level cache (MLC) (such as a level 2 (L2), a level 3 (L3), a level 4 (L4), or other levels of cache), a last level cache (LLC), and/or combinations thereof. Moreover, various components of the processor 102-1 may communicate with the shared cache 108 directly, through a bus (e.g., the bus 112), and/or a memory controller or hub. As shown in FIG. 1, in some embodiments, one or more of the cores 106 may include a level 1 (L1) cache (116-1) (generally referred to herein as “L1 cache 116”) and/or an L2 cache (not shown).

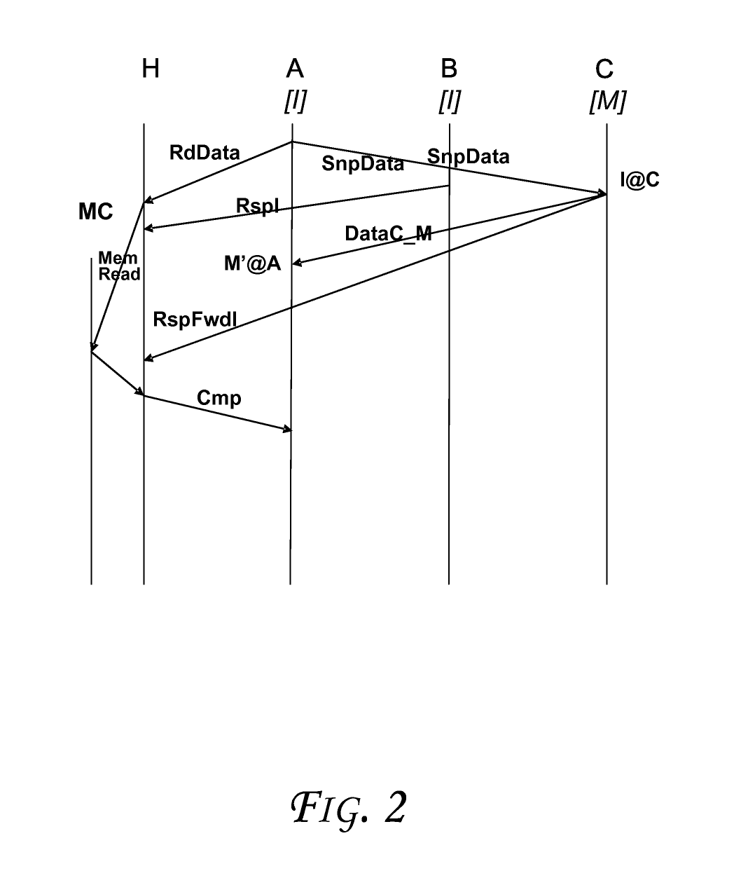

As illustrated, processor core 106 may include a logic 150 to process non-ownership load requests hitting an M-line in cache of a different processor/agent, according to an embodiment (e.g., as will be further discussed herein with reference to FIGS. 2-4). Furthermore, even though some figures illustrate logic 150 to be inside a processor or core, logic 150 may be provided within other components of computing systems discussed herein, such as within any components discussed with reference to FIG. 1 or 5-7.

Generally, multi-processor cache coherence flows are designed to manage the cross socket overhead in an efficient manner. The bandwidth (BW) to memory and interconnect BW (e.g., for a shared bus (such as Front-Side Bus (FSB)) and point-to-point bus (such as Common System Interface/Interconnect (CSI))) are at a premium and the specific implementation choices of cache coherence protocols directly influence how well BW is utilized, as well as the power efficiency of the logic and ultimately the delivered application performance.

Moreover, the processing of non-ownership reads (such as loads, RdData (Read Data) transactions in a point-to-point interconnect) that encounter Modified data in a peer cache (M state data or M-line) generally require special attention. More specifically, when a read request encounters a M-line in the local socket, it is satisfied from the local cache without any additional actions external to that processor. However, when the read request encounters a M-line in a peer processor (such as a different processor, e.g., coupled to a local processor via a socket, interconnect, etc.), there are several choices: (1) downgrade the peer copy to Shared (S) state (indicating the line may be stored in other caches and is clean-matches the corresponding data stored in the main memory) and Forward (F) a Shared (S) copy of the line to the requester while writing back the modified data to the main memory; (2) support Owned (O) state, where O state is similar to F state and allows multiple/simultaneous shares, but signifies that the line contains the latest data (not in memory), downgrade the peer copy to S and forward the line to the requester in O state, without performing a memory update; (3) downgrade the peer to Invalid (I) state (indicating the line does not hold a valid copy of the data and valid data may be in another cache or main memory) and forward the line to the requester in M state, without performing a memory update; or (4) downgrade the peer to I state and forward the line to the requester in Exclusive (E) state (indicating correct copy of data and that no other cache holds a copy of the data) while writing back the modified data to memory.

Option (1) alone may perform poorly, in part, because server benchmark data sharing is generally dominated by migratory data, with the data requestor very likely to wish to also modify the line. Because the requestor receives the line in S, it is required to perform an invalidation before it can write the line (regardless of whether there is another actual sharer in the system). This additional operation makes option (1) non-optimal from a server benchmark standpoint. Also, the subsequent write in the requesting socket is unable to be satisfied locally and requires memory read and invalidation of other copies.

Option (2) may improve upon option (1) by removing the write of the modified data back to memory (which may be tied to the eviction of the 0 state line rather than the peer Rd request). For single-writer/multiple-reader data, it behaves the same as option (1) (as it allows efficient transition to S state (multiple readers) from M state (single writer)), and also has the same drawbacks for server benchmark migratory data. Similar to Option (2), option (3) may avoid the update to memory but is optimized for migratory traffic patterns. The requestor, receiving the line in M state is now allowed to modify the data at will. However this flow has a drawback for single-write/multiple-reader patters as the line is not transitioned to a shared (S-line) as long as it remains cached. Hence, subsequent read operations will migrate the data across processors, while invalidating the local copy. For a heavily shared line, the line will endlessly ping-pong between the sharing processors' caches, leading to unacceptable performance.

Option (4) may represent the most balanced choice amongst the four options mentioned above, for supporting migratory patterns as well as single-writer/multiple-reader patterns. In the case of migratory patterns, it allows a subsequent write locally as it already has an E copy of the line. In case of single-writer/multiple reader, it is able to satisfy the subsequent readers without invalidating the local copy (downgrade the local copy to S state and forward a shared {S, F} copy to the subsequent requester). The main drawback with this option is similar to option (1), in that it requires writing back of the modified data to memory. Thus, it consumes additional interconnection and memory BW.

In addition to the interconnect bandwidth implications, the writeback may also cause complications at the home memory controller for the requested address. To minimize clean memory read time, the Rd transaction may be forwarded to the home memory controller, which initiates a memory prefetch. The peer agent then initiates a writeback to memory (referred to as implicit Write Backs—iWB) to the same address. The memory controller then manages both a read and a write to the same address. The iWB may be considered as a sub-action of the originating read request and therefore the original read request cannot be completed until both transactions finish. This holds up the outstanding request buffer at the requester and thus limits the number of outstanding requests that may be sent and limits BW loss. Furthermore, the read/write address conflict takes additional processing at the memory controller, and is often a slow flow. The memory controller will often only be able to accept a single transaction against a given memory address, which requires the read and the write to be serialized, further adding to the delay. Additionally, processing of conflicts is slow and requires the coherent flow to work through fairly convoluted and slow flow. iWBs naturally represent a conflict as the write is matching a pending read (in fact the write is due to the read) and thus the conflicting request and the write to the same address need to be processed simultaneously at the memory controller, making the complete transaction drain slowly.

Some of the embodiments address the drawbacks of all the above options, supporting migratory and single-writer/multiple-reader while avoiding an iWB. More particularly, FIG. 2 illustrates a flow diagram for processing non-ownership load requests hitting an M-line in cache of a different agent, according to an embodiment. Generally, in a coherent memory system, multiple agents (e.g., processors with caches) may be present and a memory address is associated with a particular location in the system. This location (at a “home agent” or otherwise maintained/managed by a home agent) is generally referred to as the “home node” of a memory address. Moreover, in distributed cache coherence protocols, caching agent(s) (which refers to agents that are part of the coherence protocol, e.g., by having or managing a cache memory that is part of the coherence protocol) may send requests to home agents which control coherent access to corresponding memory spaces. Each agent may have access to its cache/memory through a Memory Controller (MC).

As shown in FIG. 2, multiple agents labeled H, A, B, and C may be present in the system. When a RdData from a requester (A) (e.g., shown as snoop data (SnpData) in FIG. 2) encounters a peer M-state (e.g., at agent C), the cache line at the peer agent (C) is downgraded to I and the line is forwarded in M-state to the requester (without iWB). However, the line is filled into the requester in a M′ state (also referred to herein as “alternative modified”). M′ behaves like an M-line from a coherence perspective, except it additionally signifies that the line was forwarded in M in response to a RdData request. The transaction is then complete on receiving a ‘cmp’ from H.

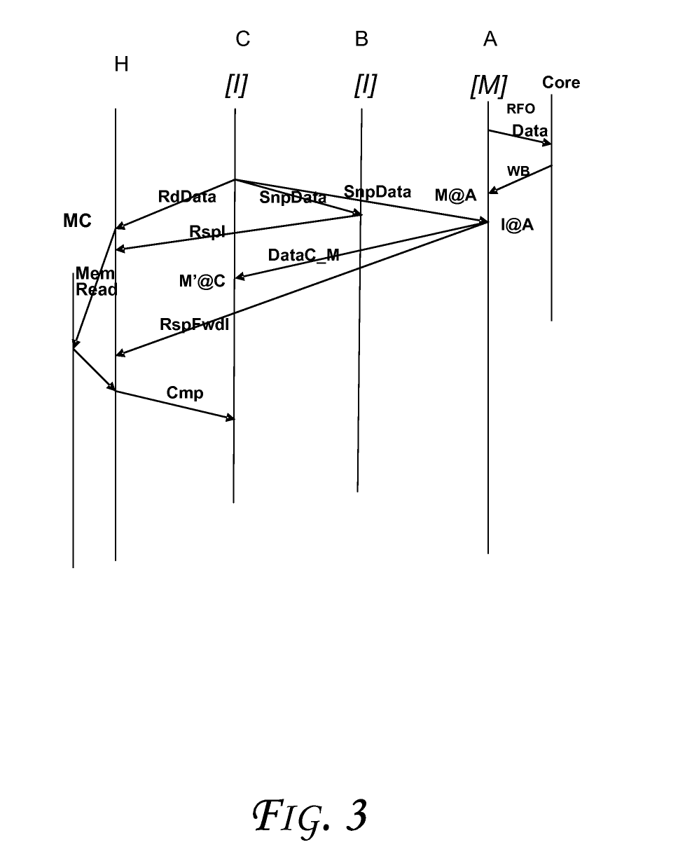

Referring to FIG. 3, shows the handling of the state transition of a line M′ state on an internal write. On a local internal write, the M′ line is migrated to M indicating the line has been modified locally and thus it loses the M′ attribute. The figure also shows the subsequent handling of the line on another RdData request from another peer, which effectively mimics the behavior outlined in FIG. 2.

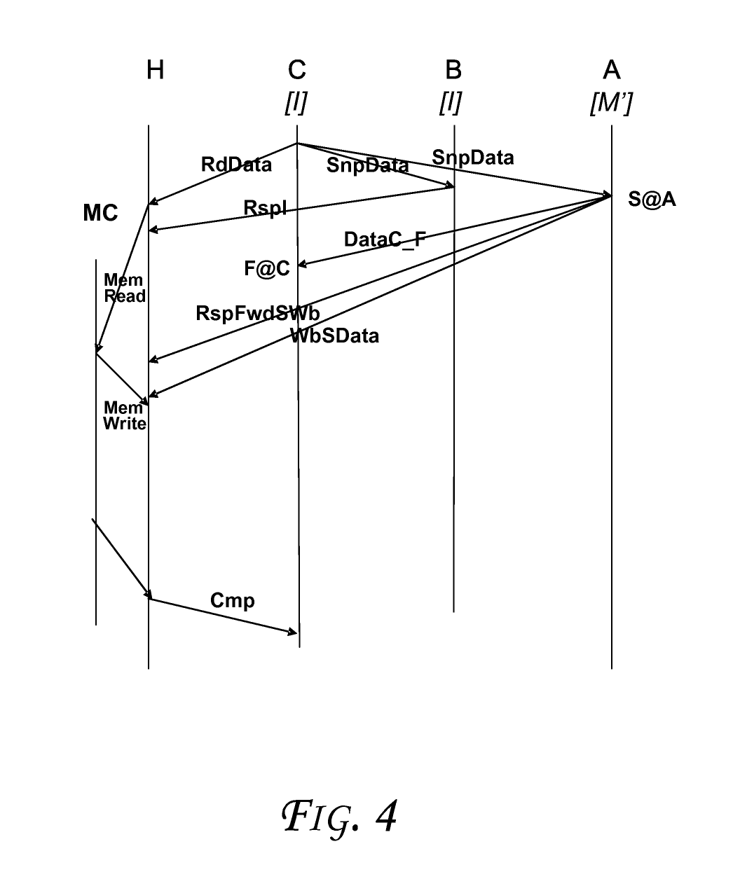

Referring to FIG. 4, in a single-writer/multiple-reader scenario, once the line is filled at the requester in the M′ state, there is typically no update to the state of the same line based on a subsequent request from an agent of the local socket. The local reads may not change the state of the line. If the local request is then followed by a remote RdData request, which encounters a M′ line in the local processor, actions outlined in option (1) above may be followed, e.g., downgrade the present owner state to S, and forward a shared {S, F} copy to the remote requester, e.g., along with a iWB in an embodiment.

Thus, the ability to fill the line in M′ results in distinguishing of the follow-up action on a subsequent RdData from a remote socket. If the line remains in M′ (as there are no local updates, for example), it indicates a multiple-shares situation and we can process the subsequent request to transition the line to shared state. When compared to any of the above options that process read sharing optimally, this has the same number of iWB (except for option (2), which has none). However, if the line has transitioned from M′ to M, it indicates a data-migratory pattern, and subsequent Rd is processed as we did in option (3) except that the requester loads the line in M′ as opposed to M (e.g., forward M copy and downgrade local copy to I).

In an embodiment, the M′ state may be supported as an additional state encoding in the last level cache, requiring no additional state bits (assuming that we have not used up all the available encoding space). In addition, it is possible to always fill data received in M-state as M′. This is possible because data lines brought in M-state by RdInvOwn (update requests) will perform a subsequent core-Write Back (WB) (eviction of the core update that was cached in the higher level caches), which will transition the line subsequently to M. Also, given that the M′ and M behave the same way from a coherence processing (ordering, etc.), it is a fairly simple change, for example, as opposed to the ‘O’ state implementations.

In some embodiments, techniques discussed herein may be applied to server workloads that are multi-threaded and share data contents across threads. In one embodiment, modified lines are managed in the system in an optimal manner, e.g., by allowing both migratory flows and single-writer/multiple-sharer MP (Multi-Processor) traffic patterns to be satisfied in an optimal manner. Moreover, the data flows introduced herein are transparent to most existing coherence/snoop and transaction processing flows.

FIG. 5 illustrates a block diagram of an embodiment of a computing system 500. In various embodiments, one or more of the components of the system 500 may be provided in various electronic devices capable of performing one or more of the operations discussed herein with reference to some embodiments of the invention. For example, one or more of the components of the system 500 may be used to perform the operations discussed with reference to FIGS. 1-4. Also, various storage devices discussed herein (e.g., with reference to FIGS. 1 and/or 6) may be used to store data, operation results, etc. Additionally, various components of system 500 may include the logic 150. Even though presence of logic 150 is shown in some components of system 500, logic 150 may be present in more or less components.

Moreover, the computing system 500 may include one or more central processing unit(s) (CPUs) 502 or processors that communicate via an interconnection network (or bus) 504. The processors 502 may include a general purpose processor, a network processor (that processes data communicated over a computer network 503), or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors. Moreover, the operations discussed with reference to FIGS. 1-4 may be performed by one or more components of the system 500.

A chipset 506 may also communicate with the interconnection network 504. The chipset 506 may include a memory control hub (MCH) 508. The MCH 508 may include a memory controller 510 that communicates with a memory 512. The memory 512 may store data, including sequences of instructions that are executed by the CPU 502, or any other device included in the computing system 500. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

The MCH 508 may also include a graphics interface 514 that communicates with a display 516. In one embodiment of the invention, the graphics interface 514 may communicate with the display 516 via an accelerated graphics port (AGP). In an embodiment of the invention, the display 516 may be a flat panel display that communicates with the graphics interface 514 through, for example, a signal converter that translates a digital representation of an image stored in a storage device such as video memory or system memory into display signals that are interpreted and displayed by the display 516. The display signals produced by the interface 514 may pass through various control devices before being interpreted by and subsequently displayed on the display 516.

A hub interface 518 may allow the MCH 508 and an input/output control hub (ICH) 520 to communicate. The ICH 520 may provide an interface to I/O devices that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the CPU 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and a network interface device 530, which may be in communication with the computer network 503. In an embodiment, the device 530 may be a NIC capable of wireless communication. Other devices may communicate via the bus 522. Also, various components (such as the network interface device 530) may communicate with the MCH 508 in some embodiments of the invention. In addition, the processor 502 and the MCH 508 may be combined to form a single chip. Furthermore, the graphics interface 514 may be included within the MCH 508 in other embodiments of the invention.

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 500 may be arranged in a point-to-point (PtP) configuration such as discussed with reference to FIG. 6. For example, processors, memory, and/or input/output devices may be interconnected by a number of point-to-point interfaces.

More specifically, FIG. 6 illustrates a computing system 600 that is arranged in a point-to-point (PtP) configuration, according to an embodiment of the invention. In particular, FIG. 6 shows a system where processors, memory, and input/output devices are interconnected by a number of point-to-point interfaces. The operations discussed with reference to FIGS. 1-5 may be performed by one or more components of the system 600. Also, various components of system 600 may include the logic 150. Even though presence of logic 150 is shown in some components of system 600, logic 150 may be present in more or less components.

As illustrated in FIG. 6, the system 600 may include several processors, of which only two, processors 602 and 604 are shown for clarity. The processors 602 and 604 may each include a local memory controller hub (MCH) 606 and 608 to couple with memories 610 and 612. The memories 610 and/or 612 may store various data such as those discussed with reference to the memory 512 of FIG. 5.

The processors 602 and 604 may be any suitable processor such as those discussed with reference to the processors 502 of FIG. 5. The processors 602 and 604 may exchange data via a point-to-point (PtP) interface 614 using PtP interface circuits 616 and 618, respectively. The processors 602 and 604 may each exchange data with a chipset 620 via individual PtP interfaces 622 and 624 using point to point interface circuits 626, 628, 630, and 632. The chipset 620 may also exchange data with a high-performance graphics circuit 634 via a high-performance graphics interface 636, using a PtP interface circuit 637.

At least one embodiment of the invention may be provided by utilizing the processors 602 and 604. For example, the processors 602 and/or 604 may perform one or more of the operations of FIGS. 1-5. Other embodiments of the invention, however, may exist in other circuits, logic units, or devices within the system 600 of FIG. 6. Furthermore, other embodiments of the invention may be distributed throughout several circuits, logic units, or devices illustrated in FIG. 6.

The chipset 620 may be coupled to a bus 640 using a PtP interface circuit 641. The bus 640 may have one or more devices coupled to it, such as a bus bridge 642 and I/O devices 643. Via a bus 644, the bus bridge 643 may be coupled to other devices such as a keyboard/mouse 645, the network interface device 630 discussed with reference to FIG. 6 (such as modems, network interface cards (NICs), or the like that may be coupled to the computer network 503), audio I/O device, and/or a data storage device 648. The data storage device 648 may store code 649 that may be executed by the processors 602 and/or 604.

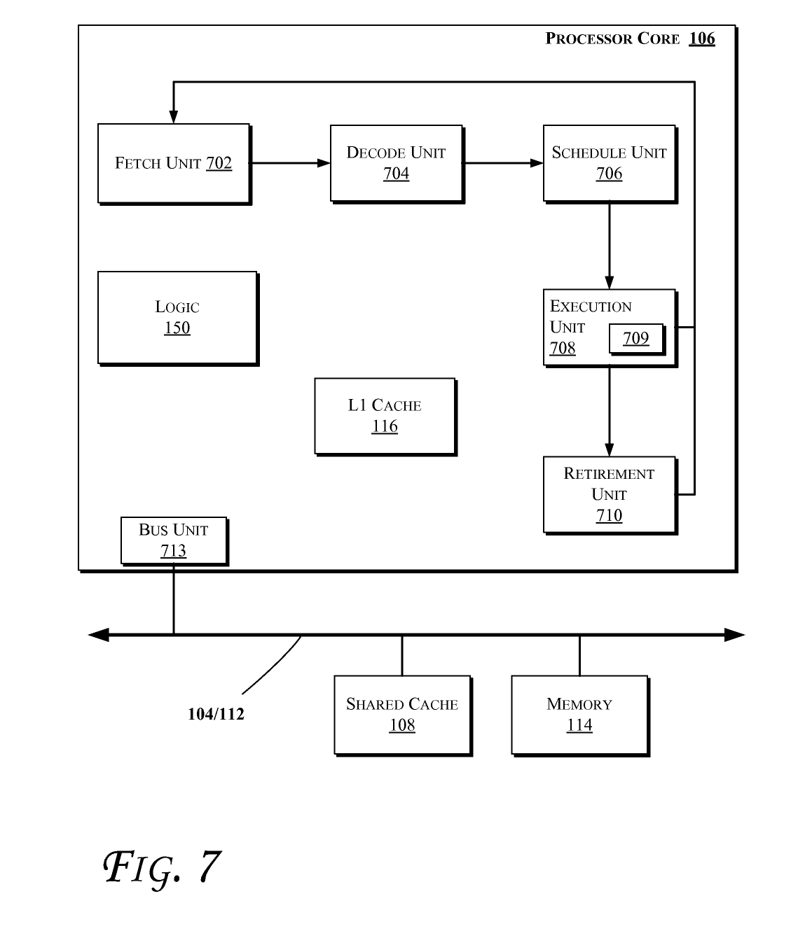

FIG. 7 illustrates a block diagram of portions of a processor core and other components of a computing system, according to an embodiment of the invention. In an embodiment, at least some of processors discussed herein (e.g., with reference to FIG. 1, 5, or 6) may include one or more of the component of the processor core 106 shown in FIG. 7. Also, a processor may include a single or multi-core 106, which may be homogeneous/symmetric or heterogeneous/asymmetric, etc. such as discussed herein, e.g., with reference to FIG. 1, 5, or 6. In one embodiment, the arrows shown in FIG. 7 illustrate the flow direction of instructions through the core 106. One or more processor cores (such as the processor core 106) may be implemented on a single integrated circuit chip (or die) such as discussed with reference to FIG. 1. Moreover, the chip may include one or more shared and/or private caches (e.g., cache 108 of FIG. 1), interconnections (e.g., interconnections 114 and/or 112 of FIG. 1), memory controllers, or other components.

As illustrated in FIG. 7, the processor core 106 may include a fetch unit 702 to fetch instructions for execution by the core 106. The instructions may be fetched from any storage devices such as the memory 114 and/or the memory devices discussed with reference to FIG. 5 or 6. The core 106 may optionally include a decode unit 704 to decode the fetched instruction. In an embodiment, the decode unit 704 may decode the fetched instruction into a plurality of uops (micro-operations). Some embodiments of the processor core 106 may not include decode unit 704. Hence, the core 106 may process instructions without decoding them. Additionally, the core 106 may include a schedule unit 706. The schedule unit 706 may perform various operations associated with storing decoded instructions (e.g., received from the decode unit 704) until the instructions are ready for dispatch, e.g., until all source values of a decoded instruction become available.

In one embodiment, the schedule unit 706 may schedule and/or issue (or dispatch) decoded instructions to an execution unit 708 for execution. The execution unit 708 may execute the dispatched instructions after they are dispatched (e.g., by the schedule unit 706) and, if applicable, decoded (e.g., by the decode unit 704). In an embodiment, the execution unit 708 may include more than one execution unit, such as one or more memory execution units, one or more integer execution units, one or more floating-point execution units (709), or other execution units. The execution unit 708 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 708.

Further, the execution unit 708 may execute instructions out-of-order. Hence, the processor core 106 may be an out-of-order processor core in one embodiment. The core 106 may also include a retirement unit 710. The retirement unit 710 may retire executed instructions (e.g., in order) after they are committed. In an embodiment, retirement of the executed instructions may result in processor state being committed from the execution of the instructions, physical registers used by the instructions being de-allocated, etc.

The core 106 may further include the logic 150 (such as the logic 150 discussed with respect to any of the previous figures). Additionally, the core 106 may include a bus unit 713 to allow communication between components of the processor core 106 and other components (such as the components discussed with reference to FIG. 1, 5, or 6) via one or more buses (e.g., buses 114 and/or 112).

In various embodiments of the invention, the operations discussed herein, e.g., with reference to FIGS. 1-7, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed herein.

Additionally, such tangible computer-readable media may be downloaded as a computer program product, wherein the program may be transferred from a remote computer (e.g., a server) to a requesting computer (e.g., a client) by way of data signals in a propagation medium via a communication link (e.g., a bus, a modem, or a network connection).

Reference in the specification to “one embodiment,” “an embodiment,” or “some embodiments” means that a particular feature, structure, or characteristic described in connection with the embodiment(s) may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a first agent to change a state of a first data from a modified state to an invalid state in response to a read request from a second agent, wherein the first data is to be stored in a first memory of the first agent; and
wherein the first agent is to forward the first data to the second agent in a modified state and the second agent is to store the first data in a second memory of the second agent in an alternative modified state.

2. The apparatus of claim 1, wherein the alternative modified state is to indicate the first data has been forwarded to the second agent in modified state in response to a read request.

3. The apparatus of claim 1, wherein the second agent is to change the state of the first line, stored in the second memory, to a modified state from the alternative modified state in response to a subsequent request from an agent of a local socket.

4. The apparatus of claim 1, wherein the second agent is to maintain the first line, stored in the second memory, in the alternative modified state in response to a subsequent request from an agent of the local socket in a single-writer and multiple-reader scenario.

5. The apparatus of claim 1, wherein the second agent is to change the state of the first line, stored in the second memory, to a shared state from the alternative modified state in response to a subsequent request from an agent of a local socket followed by request from an agent of a remote socket in a single-writer and multiple-reader scenario.

6. The apparatus of claim 5, wherein the second agent is to forward the first line, stored in the second memory, to the agent of the remote socket in response to the change to the shared state.

7. The apparatus of claim 1, wherein a last level cache is to comprise an encoding for the alternative modified state.

8. The apparatus of claim 1, wherein the second memory is to comprise a cache and the first data is to comprise a cache line.

9. The apparatus of claim 1, wherein the first agent is to forward the first data to the second agent without issuing an implicit write back.

10. The apparatus of claim 1, wherein the first memory is to comprise a cache and the first data is to comprise a cache line.

11. The apparatus of claim 10, wherein the cache is to comprise a level 1 cache, a level 2 cache, a level 3 cache, or a last level cache.

12. The apparatus of claim 1, further comprising a processor that is to comprise one or more of the first agent and the first memory.

13. The apparatus of claim 12, wherein the processor is to comprise a plurality of processor cores and wherein at least one of the plurality of processor cores is to comprise one or more of the first logic or the storage unit.

14. A method comprising:
storing a first data in a first memory; and
changing a state of the first data from a modified state to an invalid state in response to a read request,
wherein the first data is to be forwarded in a modified state and stored in a second memory in an alternative modified state.

15. The method of claim 14, wherein the alternative modified state is to indicate the first data has been forwarded in modified state in response to a read request.

16. The method of claim 14, further comprising changing the state of the first line to a modified state from the alternative modified state in response to a subsequent request from an agent of a local socket.

17. A system comprising:
a memory to store a first data;
a first processor to fetch the first data and store it in a cache coupled to the first processor, wherein the first processor is to change a state of the first data from a modified state to an invalid state in response to a read request from a second processor,
wherein the first processor is to forward the first data to the second processor in a modified state and the second processor is to store the first data in a second cache, coupled to the second processor, in an alternative modified state.

18. wherein the alternative modified state is to indicate the first data has been forwarded to the second agent in modified state in response to a read request.

19. The system of claim 17, wherein a last level cache is to comprise an encoding for the alternative modified state.

20. The system of claim 17, further comprising an audio device coupled to the first logic.
